(19) United States
(12) Patent Application Publication
(10) Pub. No.: US 2025/0366955 A1
(43) Pub. Date: Dec. 4, 2025

(54) DENTAL IMPLANT WITH MODIFIED THREAD GEOMETRY AND CONCAVE APICAL END

(71) Applicant: Massimo AFFLITTO, Torino (IT)

(72) Inventor: Massimo AFFLITTO, Torino (IT)

(21) Appl. No.: 18/675,864

(22) Filed: May 28, 2024

(51) Int. Cl. A61C 8/00

(52) U.S. Cl. CPC A61C 8/0068

(57) ABSTRACT

A frusto-conical endosseous dental implant with an anti-rotational internal connection for supporting an abutment or a dental prosthesis is provided. The dental implant has two portions, a shorter unthreaded cylindrical or frusto-conical transgingival neck with a smooth surface and a longer threaded frusto-conical endosseous portion with a blasted surface, tapered over at least part of its length. An imaginary coronal portion includes the transgingival neck, coronal to the endosseous portion, and the internal connection, apically-extending. The transgingival neck includes a coronal end opening to internal connection. An imaginary apical portion includes a concave apical end opposite the coronal end, coronally-extending.

### FIELD OF THE INVENTION

The present invention relates to a dental implant characterized by a double-tapered thread geometry to optimize lateral bone compression and therefore primary stability and by a concave apical end to minimize the periapical vertical bone compression.

### BACKGROUND OF THE INVENTION

Dental implants are designed for placement into the alveolar or basal bone of the mandible or maxilla while maintaining the endosseous portion within the bone and, if present, the transgingival neck (often called smooth neck, transgingival portion or etched/machined neck) within the gingiva. Endosseous portion exhibits screw threads throughout most or all its length; therefore, it is often used as a synonym for threaded portion. The endosseous portion will hereinafter be referred to as the threaded portion. Blasted surface of endosseous portion promotes osseointegration, while smooth surface of transgingival neck, if present, minimize plaque adhesion thus prevents peri-implantitis. Etched and machined surfaces are relatively smooth compared to blasted surface. Etched surface is a modern refinement of the machined surface. It should be noted that if blasted surface extends over to coronal end of the implant, situation corresponding to the absence of the smooth neck (i.e., smooth neck=0 millimeters), can contribute to perimplantitis if exposed to soft tissue.

There is an extensive variation in types of implants and their designs, as well as the terms used in Implant Dentistry. Dental implants on the market today come in several different configurations. Modern dental implants are designed with an endosseous macrostructure, or thread portion, that optimizes initial stability (so-called primary stability) and an endosseous microstructure, or blasted surface, which promotes osseointegration (so-called secondary stability). Clinically, primary stability is achieved by “controlled bone compression”. Bone compression is often called osteocompression or bone expansion.

Primary stability is influenced by both the threaded portion design and osteotomy width underpreparation (i.e. drilling protocol). The drilling protocol depends on the bone density values: all drills in dense bone, all drills except last drill in intermediate bone, only one to two beginning burs and then osteotomes in soft bone.

Let's examine now two dental implants, without smooth transgingival neck, on the market. Both Legacy2™ (FIG. 1A) and Legacy1™ (FIG. 1B) implants have some common features (e.g., an anti-rotational internal connection 18, coronal mini-thread 14, longitudinal self-tapping grooves 19 and convex apical end 13) but differ in the threaded portion 15. Threaded portion 15 optimizes initial stability (so-called primary stability) while coronal mini-thread 14 (the technological advances over the past decade have led implant companies to eliminate this feature in the latest implant models) reduces osteocompression around the coronal portion 16. Longitudinal self-tapping grooves 19 extend from the convex apical end 13 to the coronal portion 16 and may involve an entire endosseous length. Anti-rotational internal connection 18 is used to join the dental implant to various instruments and components and, finally, to an abutment or prosthesis.

Let's define now some implant thread geometry features. Currently, the most thread shapes in dental implant include V-shaped, trapezoidal-shaped (which replaced square-shaped) and reverse buttress-shaped thread. As illustrated in FIG. 2, thread pitch (TP) can be defined as the distance from a point on one thread to a corresponding point on the adjacent thread, measured parallel to the longitudinal axis of the implant. Furthermore, thread depth (TD) is the distance between the major and minor diameter of thread, while thread thickness (TT) is the distance in the same axial plane between the coronal most and the apical most part at the tip of a single thread. Finally, angle β1 defines the taper of inside thread diameter while angle β2 defines the taper of outside thread diameter. Angle β2 essentially of 0° defines a straight/cylindrical implant, while tapered/frusto-conical implant is normally characterized by the angle β2≥1.5°. They also exist straight implants with tapered apex.

Legacy2™ (FIG. 1A) and Legacy1™ (FIG. 1B) implants have a threaded portion 15 with a “constant thread pitch” but that is different in the following aspects:
1) Legacy2™ implant has modern “reverse buttress” and “trapezoidal” threads while Legacy 1 implant has outdated “V thread”.
2) Legacy 1™ implant is representative of the outdated “single-tapered thread geometry” or “uniform depth thread” since angle β1 =angle β2.

Legacy2™ implant is representative of the modern “double-tapered thread geometry” or “thread progressively deeper in the apical direction (AD)” since angle β1 is greater than angle β2 and, frequently, angle β2≥1.5°.

More recently, a subsequent improvement has been the introduction, by implant companies, of a double-tapered thread geometry characterized by thread progressively deeper and thinner in the apical direction (see FIGS. 1A and 2), thus generating a gradual transition from the compressing trapezoidal-shaped thread, placed coronally, to the cutting reverse buttress-shaped thread one (also known as sawtooth profile), placed apically. This latest change of thread geometry works, but the present invention overcomes its drawbacks. Indeed, this latest change of thread geometry, of wide clinical use, presents at least two different drawbacks. After drilling of the implant site, the implant is conventionally placed in an undersized socket free hand or through the surgical guide. A first problem that may occur with this thread design is that the “thin, sharp and deep apical threads” may lead to false bone paths compared to the surgical socket and therefore impede optimal insertion according to the presurgical implant plan.

Furthermore, bone density normally decreases from the bone surface (where the coronal threads are placed) to the depth (where the apical threads are placed). The thin, sharp and deep apical threads allow easy advancement of the implant but does not compress the soft apical bone to dissipate the load. Therefore, as a second drawback, the “thin, sharp and deep apical threads associated with thick and shallow coronal threads” increase the occlusal load transfer to the coronal dense/cortical bone (CDB) and simultaneously decrease it to the apical soft/cancellous bone (ASB). This simultaneous overloading of CDB and underloading of ASB may contribute to increased coronal bone resorption (normally referred to as MBL, Marginal Bone Loss).

Bone is best able to compressive forces and significantly less resistant to shear forces. More precisely, Bone is strongest when loaded in compression and 65% weaker when loaded in shear. Since occlusal load transfer is not uniform across dense and soft bone, thread design should facilitate great transfer of compressive forces to ASB to dissipate occlusal forces and small transfer of shear forces to CDB to avoid detrimental occlusal overload that may generate MBL. This necessary distribution of occlusal forces to the bone suggests the thread design described by the invention (see FIGS. 3A, 3B and 4C) which results in contrast with the prior art (see FIGS. 1A and 2).

As the threads advance, during implant insertion, they inevitably create small bone chips that can accumulate in the bottom of the implant site or being forced into the axial wall of the osteotomy, resulting in difficulty in seating the implant to final depth and/or unfavorable increased insertion torque. In this way, the convex or flat apical end of prior art implants is an insuperable barrier.

Furthermore, during the healing phase (i.e., after implant insertion), the convex or flat apical end may create an undesirable periapical vertical bone compression that can generate retrograde peri-implantitis.

### SUMMARY OF THE INVENTION

A purpose of the present invention is therefore to overcome the drawbacks of prior art dental implants through a concave apical end and a double-tapered thread geometry characterized by threads progressively deeper and thicker in the apical direction (FIG. 3A), thus generating a gradual transition from the trapezoidal-shaped threads, placed apically, to the reverse buttress-shaped threads, placed coronally. In other words, as the thread progresses from a superior base of the threaded portion to the apical end of the implant, 23b and 23c respectively, the thread becomes deeper and thicker, therefore generating coronal cutting threads and apical compressing threads. The benefit is represented by the fact that an apical trapezoidal-shaped thread (as opposed to the V-shaped or reverse buttress-shaped thread) reduces the shear component of force by taking the axial load of the prosthesis and transferring a more axial load along the implant body to compress the ASB. The modified threaded portion (“thin, sharp and shallow coronal threads associated with thick and deep apical threads”) therefore creates a balanced dissipation of the load between the coronal and apical threads.

A first object of the present invention is to provide a threaded portion that makes it easier to keep the implant axis aligned with the axis of the osteotomy, during implant insertion, thanks to the greater thickness of the 3-5 apical trapezoidal threads. In short, the apical portion is self-centering.

A second object of the present invention is to provide a threaded portion in which both thread depth (TD) and thread thickness (TT) increase in an apical direction (AD) so as to induce both horizontal and vertical controlled bone compression, around the lateral surface of the threaded portion, during implant insertion. Furthermore, after implant insertion, is increased the thread surface of apical portion thus improving the bone-to-implant contact and consequently the implant provides optimal short-and long-term stability, both in hard and soft bone, due to its advanced apical portion. In short, the lateral surface of the threaded portion is adequately osteocompressive.

Furthermore, a third object of the present invention is to provide a concave apical end to act as a reservoir for small bone chips during implant insertion. Unlike the convex or flat apical end, the concave apical end allows maximum bone gathering during insertion of a dental implant.

Finally, a fourth object of the present invention is to provide a concave apical end to minimize the undesirable periapical vertical bone compression after implant insertion. The concave apical end has relevance in reducing compression on the periapical bone, which is the cause of retrograde peri-implantitis (periapical disease) or in avoiding lesions of vital structures such as sinus membrane perforation or mandibular nerve damage. In short, the concave apical end of the threaded portion is minimally osteocompressive.

The threaded portion also has an “increasing thread pitch” in the apical direction. As the threads advance, during implant insertion, they inevitably create small bone chips (and this fact is valid for any type of endosseous dental implant) that can easily accumulate not only on the concave apical end but also between the threads with increasing pitch in the apical direction (i.e. the lateral surface of threaded portion) without therefore unfavorably increasing the insertion torque.

In conclusion, the modified thread geometry and concave apical end, object of the present invention, are designed to promote and maintain primary stability and osseointegration of the implant. The thread geometry object of the present invention is designed to optimize precise endosseous placement of the implant without changing direction during insertion, primary stability and distribution of forces within the bone.

### BRIEF DESCRIPTION OF THE DRAWINGS

FIG. 1A is a perspective view of a first dental implant belonging to the prior art (Implant Direct®'s Legacy2™ implant),

FIG. 1B is a perspective view of a second dental implant belonging to the prior art (Implant Direct®'s Legacy1™ implant),

FIG. 2 shows, in a cross-sectional view, some implant double-tapered thread geometry features belonging to the prior art,

FIG. 3A is a cross-sectional view of the implant 20 according to the present invention,

FIG. 3B is a side view of a dental implant 20 according to the present invention,

FIG. 3C is a perspective view of the implant in FIG. 3B,

FIG. 4 shows a surgical preparation and implant insertion protocol according to the present invention.

### DETAILED DESCRIPTION

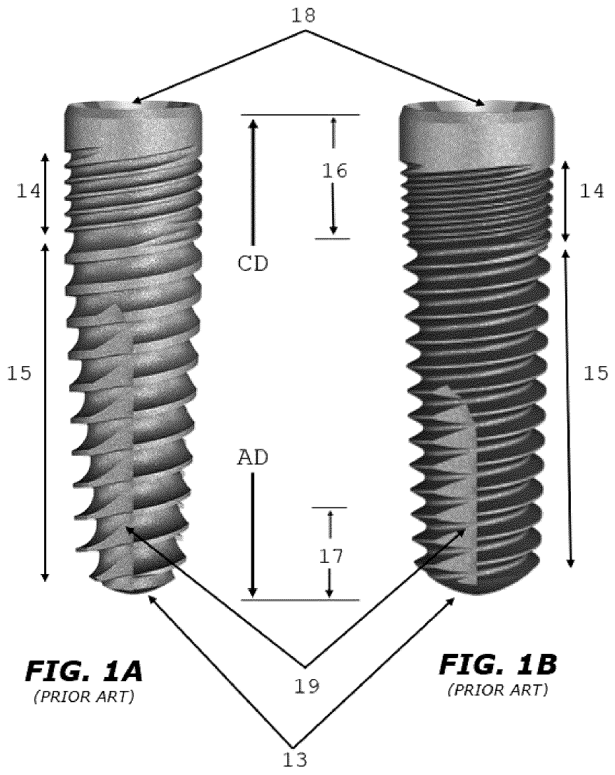

Both implants belonging to the prior art (FIGS. 1A and 1B) have a convex apical end 13, a coronal mini-thread 14, a threaded portion 15, an imaginary coronal portion 16, an imaginary apical portion 17, an anti-rotational internal connection (not shown) 18 and some longitudinal self-tapping grooves 19. Furthermore, in this application, CD is an acronym for “coronal direction” while AD is an acronym for “apical direction”.

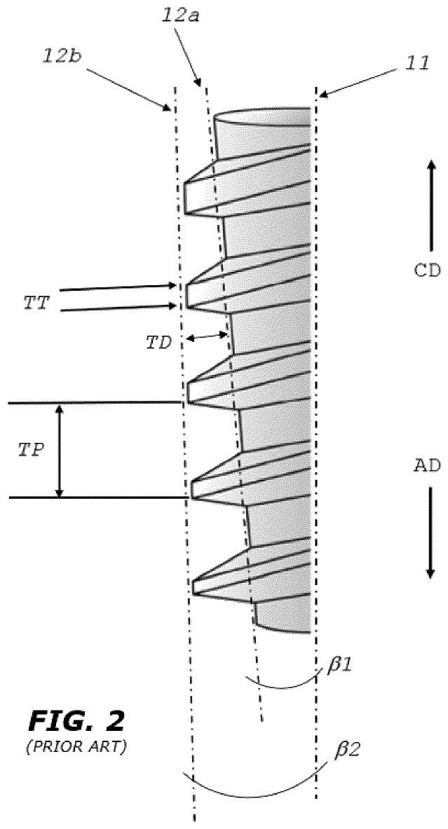

FIG. 2 shows a longitudinal axis 11 of a prior art dental implant, the imaginary internal thread line 12a and the imaginary external thread line 12b. The imaginary internal thread line 12a is at an angle β1 relative to the longitudinal axis 11; therefore, the angle β1 defines the taper of inside thread diameter. The imaginary external thread line 12b is at an angle β2 relative to the longitudinal axis 11; therefore the angle β2 defines the taper of outside thread diameter. Furthermore, in a preferred embodiment, the pitch TP, depth TD and thickness TT of the threads progressively increase in the apical direction AD.

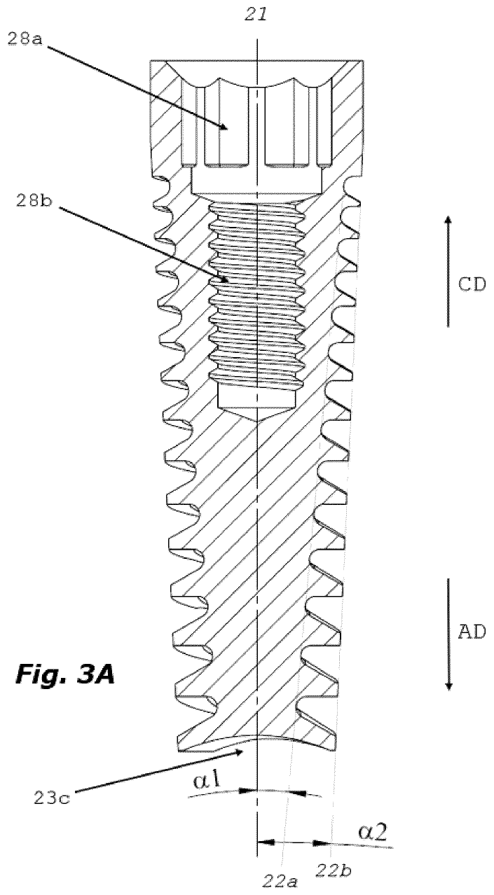

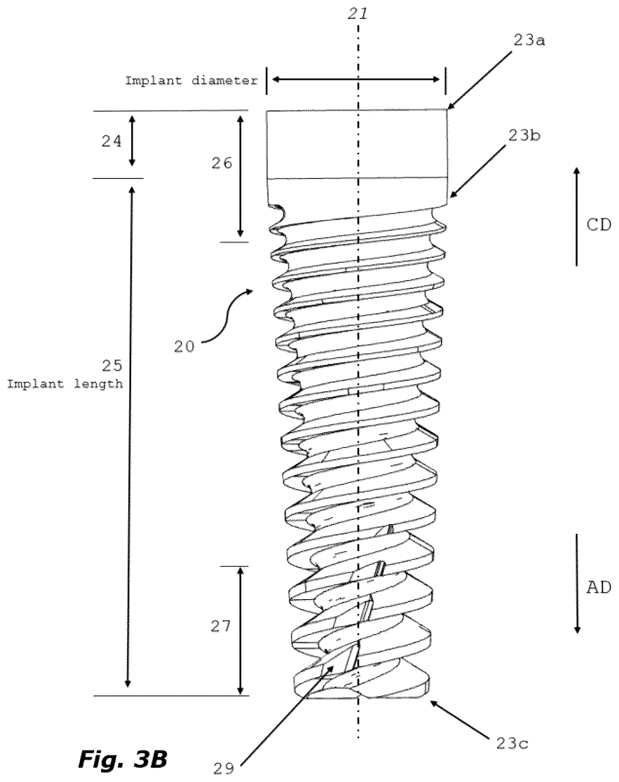

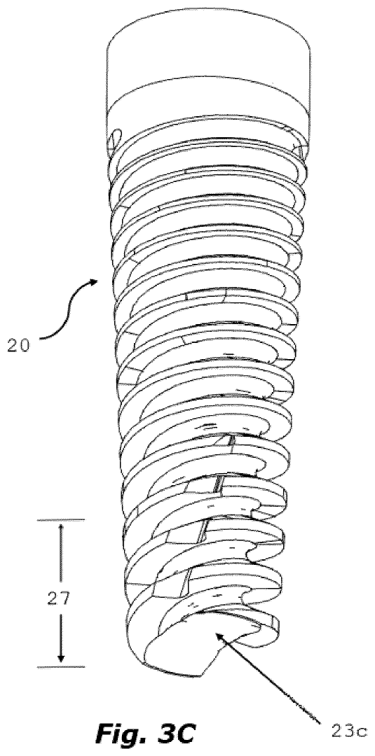

FIG. 3A shows some features of the implant 20: a longitudinal axis 21, an anti-rotational internal connection 28a, an internal thread 28b, a concave apical end 23c, an imaginary thread line 22a which represents the inside thread diameters, an imaginary thread line 22b which represents the outside thread diameters. The imaginary internal thread line 22a is at an angle al relative to the longitudinal axis 21; therefore, the angle al defines the taper of inside thread diameter. The imaginary external thread line 22b is at an angle α2 relative to the longitudinal axis 21; therefore, the angle α2 defines the taper of outside thread diameter and progressively increase.

FIG. 3B shows an implant 20 featuring a transgingival neck 24, a threaded portion 25, an imaginary coronal portion 26, an imaginary apical portion 27, a coronal end 23a, a superior base of threaded portion 23b coinciding with an inferior base of the neck, an apical end 23c, a longitudinal axis of implant 21 and at least two longitudinal self-tapping grooves 29. The implant diameter and length are also shown.

FIG. 3C shows a concave apical end 23c.

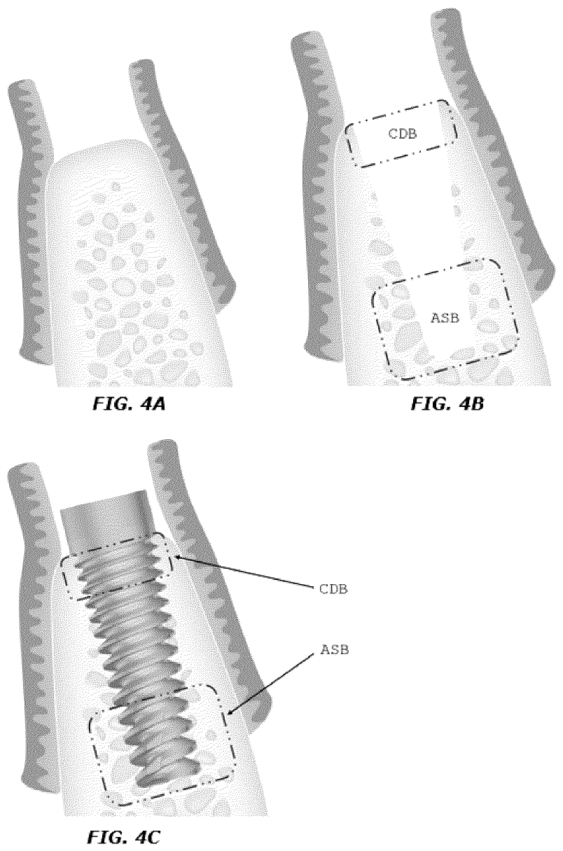

FIG. 4A shows the bone before drilling protocol, and FIG. 4B shows the bone after drilling. FIG. 4C shows the bone after placement of the implant 20. Furthermore, in this application, CDB is an acronym for “coronal dense bone” and ASB is an acronym for “apical soft bone”.

The thread, from shallow, thin and therefore sharper at the coronal portion (to reduce forces in CDB and facilitate the insertion of the implant) becomes gradually deeper and thicker at the apical portion (to optimize bone compression in ASB and therefore the primary stability).

Although the implant 20 preferably has an internal hex connection 28a, the implant 20 may have an external hex connection (not shown).

What is claimed is:

1. A dental implant comprising:
an unthreaded cylindrical or frusto-conical neck having a smooth surface, a superior base referred to as a coronal end of the dental implant, and an inferior base,
an anti-rotational internal connection that is open at the coronal end,
a threaded frusto-conical endosseous portion having a blasted surface, a superior base coinciding with the inferior base of the unthreaded cylindrical or frusto-conical neck and defining an implant diameter, an apical end opposite the coronal end, a longitudinal axis defining an implant length from the superior base of the threaded portion to the apical end, at least two longitudinal self-tapping grooves that start from the apical end and extend coronally for 3.0-6.0 mm, and a double-tapered thread geometry in which the inside thread (α1) tapers greater than the outside thread (α2) and in which, preferably, α2≥1.5°,
wherein thread pitch, thread depth and thread thickness of said threaded portion progressively increase from the superior base of the threaded portion to the apical end of the dental implant.

2. The dental implant of claim 1, wherein the apical end has a concave surface.
